(19) United States
(12) Patent Application Publication
(10) Pub. No.: US 2005/0117885 A1
(43) Pub. Date: Jun. 2, 2005

(54) DVD player and method of reproducing multimedia file using the DVD player

(75) Inventors: Kyu-Sang Lee, Seoul (KR); Jae-Hyun Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/977,468

(22) Filed: Nov. 1, 2004

(30) Foreign Application Priority Data
Jan. 16, 2003 (KR) 2003-2960

(51) Int. Cl. H04N 5/781

(52) U.S. Cl. 386/95; 386/125

(57) ABSTRACT

A DVD player and a method of reproducing multimedia files using the DVD player are provided. The DVD player and the method can improve practical applicability and usefulness of a common DVD player by enabling reproduction of multimedia (moving picture) information stored in various multimedia formats (such as, moving picture experts group (MPEG)-4, digital video express (DivX)) via codecs. Codecs that correspond to various multimedia formats are downloaded via a memory stick or other external port so that not only multimedia information stored in MPEG-2 format, which is the basic DVD format, but also multimedia information recorded in various other multimedia formats such as MEPG-4 and DivX, can be reproduced.

### CROSS-REFERENCE TO RELATED APPLICATION

This application is related to Korean Patent Application No. 2003-002960, filed on Jan. 16, 2003 and laid open Jul. 23, 2004, in the Korean Intellectual Property Office.

### BACKGROUND OF THE INVENTION

1. Field of the Invention

The present invention relates to a digital versatile disc (DVD) player. More particularly, the present invention relates to a DVD player and a method of reproducing multimedia files using a DVD player that can improve the practical applicability and usefulness of a common DVD player by enabling reproduction of multimedia information stored in various multimedia formats (such as, moving picture experts group (MPEG)-4, digital video express (DivX)) even in a typical DVD player via codecs. Codecs that correspond to various multimedia formats are downloaded via a memory stick or other external port so that not only moving picture multimedia information stored in MPEG-2 format, which is the basic DVD format, but also the multimedia information recorded in various other multimedia formats such as MEPG-4 and DivX can be reproduced.

2. Description of the Related Art

Generally, a DVD is an optical disc with a diameter of about 12 cm on which about 135 minutes of audio and video data (that is, multimedia information) that can be reproduced are digitalized and recorded. The DVD can record multimedia information such as a movie with image quality similar to television broadcasting on a disk having the same diameter as a compact disc (CD). The recording capacity of a DVD is six to eight times greater than the recording capacity of a typical CD. The recording capacity can be increased by, for example, increasing the numerical aperture of an objective lens that focuses a red semiconductor laser, whose wavelength (635-650 nm) is shorter than that of an infrared semiconductor laser (about 780 mm), used as a light source for CDs. Multimedia data (information) recorded (stored) on DVDs is condensed in an MPEG-2 format, which is an international standard format.

DVDs are usually used as a moving picture recording storage medium that can store moving picture multimedia information such as high quality movies. However, DVDs can also be used as DVD-ROMs, which represent the next generation version of CD-ROM, a read-only computer memory device. Therefore, software, personal computer (PC), and game device manufacturing industries are focusing a great deal of attention on DVDs.

As demand for access to multimedia information including moving pictures through the Internet increases, various multimedia (hereinafter, “multimedia” includes “moving picture”) formats such as MPEG-4 and DivX are being used. Along with the varied multimedia formats, codecs that correspond to the various multimedia formats also vary. For example, multimedia contents in DivX format are now more widespread than DVD titles on the Internet. Moreover, moving picture multimedia files in other types of formats are provided as well. For reference, codec is an abbreviation for “coder/decoder” or “compression/decompression.” A codec utilizes a compression algorithm for minimizing the memory storage space required for large or complex files such as video files. Decompression restores the compressed file to its original or substantially its original form. There are several standard methods for compressing and decompressing files used by codecs. Some of these methods are usually applied to the Internet in order to reduce file transmission time, while others are aimed at recording (storing) as much data as possible on a disc with a limited capacity such as a CD-ROM. Codecs are used in DVD players as well as numerous Internet products, for example, QuickTime, Netmeeting, Cu-SeeMe, and VDOphone.

In the conventional art, a codec appropriate for each multimedia format is needed to reproduce multimedia information in various formats. However, only a codec appropriate for the MPEG-2 format is installed in the conventional DVD player. Therefore, the conventional DVD player cannot reproduce moving picture multimedia information recorded in formats other than MPEG-2.

### SUMMARY OF THE INVENTION

The present invention provides a digital versatile disc (DVD) player and a method of reproducing multimedia files using the DVD player that can improve the practical applicability and usefulness of a conventional DVD player by enabling reproduction of multimedia information stored in various multimedia formats (such as, moving picture experts group (MPEG)-4, digital video express (DivX)) even in a typical DVD player via codecs. Codecs that correspond to various multimedia formats are downloaded via a memory stick or other external port so that not only moving picture multimedia information stored in MPEG-2 format, which is the basic DVD format, but also multimedia information recorded in various other multimedia formats such as MEPG-4 and DivX can be reproduced.

According to an aspect of the present invention, there is provided a DVD player, comprising a loader that reads multimedia file data stored on a DVD; a memory that stores the multimedia file data read by the loader, and multimedia file data of a personal computer (PC) or multimedia file data downloaded from the Internet; and a controller that controls the loader and the memory. The controller comprises a file system module that controls the reading of the multimedia file data by the loader and controls the read multimedia file data by extracting a portion of or the entire multimedia file from the multimedia file data; a codec module that decodes the multimedia file using a codec driver that corresponds to the file extension of the multimedia file stored in the memory; and a user interface module that outputs video and or audio data of the decoded multimedia file to a video and or audio output device. The codec module includes a plurality of codec drivers to decode multimedia files in a plurality of formats and the memory is preferably composed of a memory stick or a CD-R.

The file system module may comprise a recording format recognizer that recognizes a recording format of the multimedia file data stored in the memory; a memory manager that manages the memory; a loader controller that controls a loading location of the multimedia file data; and a decoding controller that controls a first decoding of the multimedia file data read by the loader.

The codec module preferably includes at least an MPEG-2 codec driver, an MPEG-4 codec driver, and a DivX codec driver according to the file extension of the multimedia file stored in the memory, and other codec drivers that decode a plurality of multimedia files can be added in the codec module through software upgrades.

The user interface module preferably includes a key input unit that receives signals input by a user; a display controller that controls output of video data of the multimedia file decoded in the codec module; an audio input and or output controller that controls the output of the audio data of the multimedia file decoded in the codec module; and a reproduction mode controller that outputs a control signal that controls the reproduction mode of the multimedia file to the file system module.

The loader preferably includes an optical pickup that reads multimedia file data stored in the DVD; a radio frequency amplifier that converts the multimedia file data read by the optical pickup into high-frequency signals; and a digital signal processor that converts the high-frequency signals into digital signals.

According to another aspect of the present invention, there is provided a method of reproducing multimedia files using a DVD player. The method includes reading a multimedia file stored on a DVD and performing a first decoding; storing the multimedia file that went through the first decoding, and storing a multimedia file of a PC or a multimedia file downloaded from the Internet; performing a second decoding by a codec driver that corresponds to a file extension of the stored multimedia file; and outputting video and or audio data of the multimedia file that went through the second decoding to a video and or audio output device.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram of a digital versatile disc (DVD) player according to an embodiment of the present invention;

FIG. 2 is a detailed structural diagram of a loader of the DVD player illustrated in FIG. 1 according to an embodiment of the present invention;

FIG. 3 is a detailed structural diagram of a file system module of the DVD player illustrated in FIG. 1 according to an embodiment of the present invention;

FIG. 4 is a detailed structural diagram of a codec module of the DVD player illustrated in FIG. 1 according to an embodiment of the present invention;

FIG. 5 is a detailed structural diagram of a user interface module of the DVD player illustrated in FIG. 1 according to an embodiment of the present invention;

FIG. 6 is a flowchart illustrating a method of reproducing a multimedia file according to an embodiment of the present invention;

FIG. 7 is a flowchart illustrating a first decoding step of a method of reproducing a multimedia file according to an embodiment of the present invention; and

FIG. 8 is a flowchart illustrating a second decoding step of a method of reproducing a multimedia file according to an embodiment of the present invention.

### DETAILED DESCRIPTION OF THE EXEMPLARY EMBODIMENTS

A digital versatile disc (DVD) player and a method of reproducing multimedia files using the same will now be described more fully with reference to the accompanying drawings, in which exemplary embodiments of the invention are shown. Descriptions of techniques or structures not central to the present invention have been omitted for the sake of clarity. In addition, the terminology that follows is defined according to the functions of the devices in the embodiments of the present invention and may change according to, for example, conventional usage or the intentions of a user or operator. Therefore, definitions should be derived based on the overall contents of the present application.

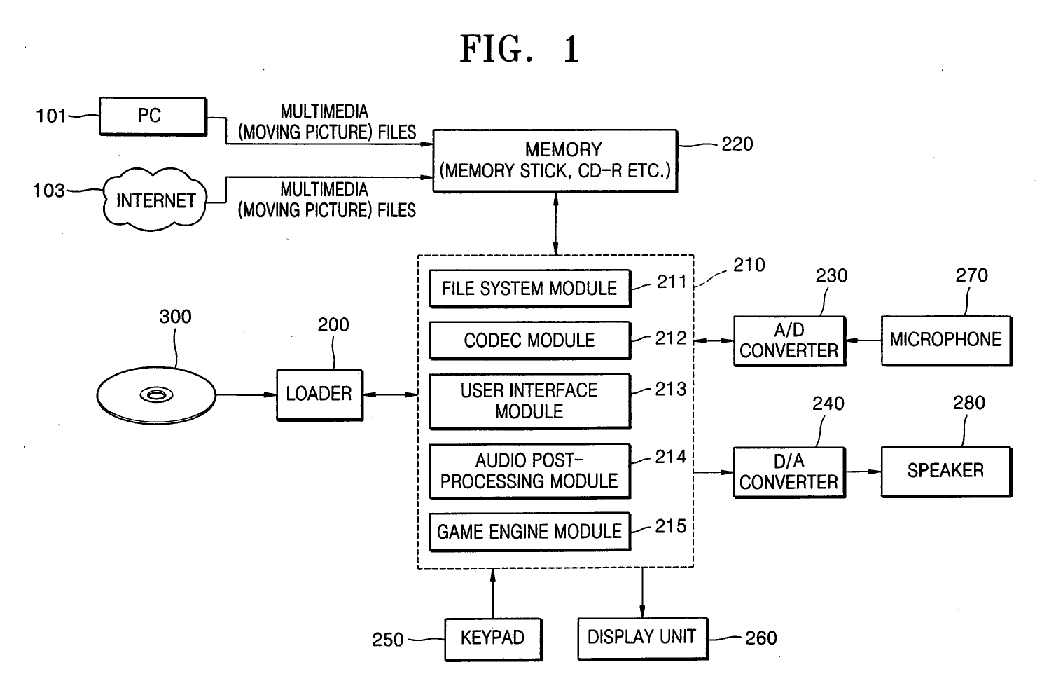

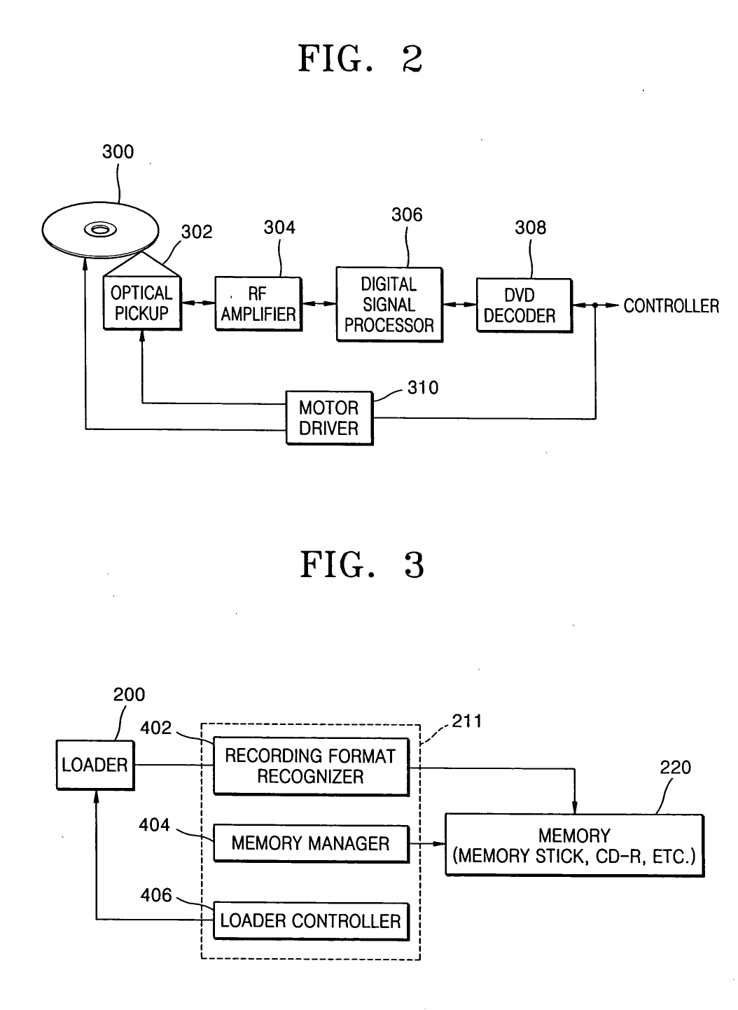

FIG. 1 is a schematic diagram of a DVD player according to an embodiment of the present invention. FIGS. 2 through 5 are detailed structural diagrams of a loader 200, a file system module 211, a codec module 212, and a user interface module 213, respectively.

Referring to FIG. 1, the DVD player includes the loader 200, a controller 210, a memory 220, an audio-to-digital (A/D) converter 230, a digital-to-audio (D/A) converter 240, a keypad 250, a display unit 260, a microphone 270, and a speaker 280. The memory 220 includes a storage medium (such as, a memory stick, a CD-R or other suitable memory device). The memory 220 reads multimedia files via the reader 210 and also stores multimedia files input through a personal computer (PC) 101 or downloaded from the Internet 103.

The loader 200 reads data stored in a DVD 300 and outputs the data to the controller 210. The loader 200, as illustrated in FIG. 2, comprises an optical pickup 302, a radio frequency (RF) amplifier 304, a digital signal processor 306, a DVD decoder 308, and a motor driver 310.

The controller 210 stores the data input from the loader 200 in the memory 220 or outputs the data through the speaker 280 via the D/A converter 240 or the display unit 260. The controller 210 is configured as software so that it can perform multi-tasking. In this embodiment, if the software for multi-tasking is categorized according to its types of operations, the controller 210 includes the file system module 211, the codec module 212, the user interface module 213, an audio post-processing module 214, and a game engine module 215. The file system module 211 extracts multimedia files from the data read from the DVD 300, or from the PC 101, or downloaded from the Internet 103, and manages the multimedia files. The file system module 211 includes a recording format recognizer 402, a memory controller 404, and a loader controller 406, as illustrated in FIG. 3.

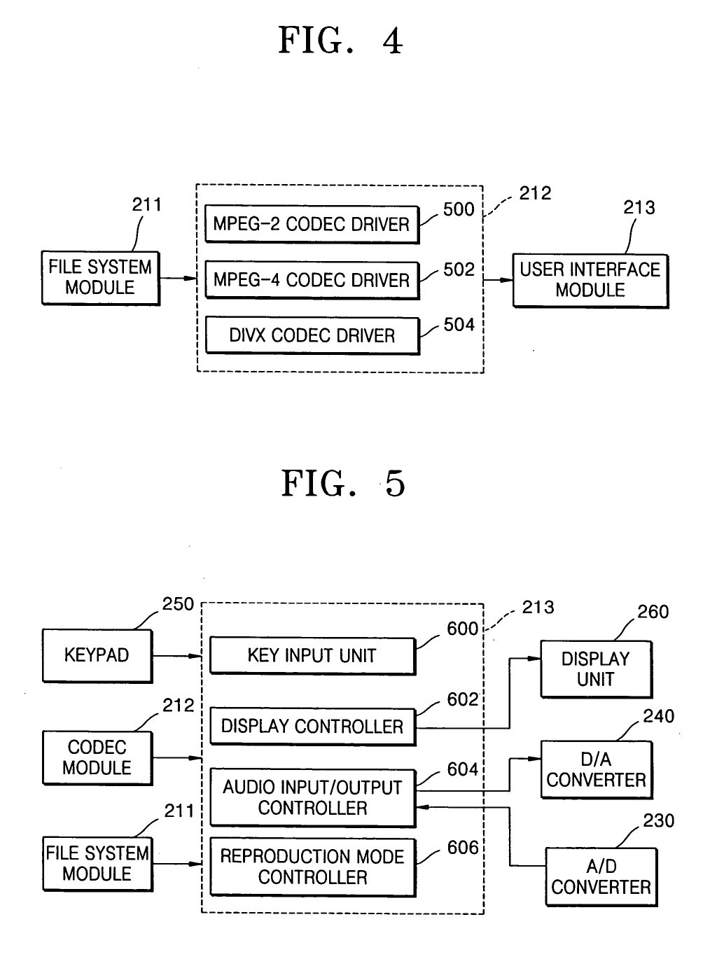

The codec module 212 decodes the multimedia files extracted at the file system module 211, and restores the multimedia files into video and audio data. Here, the codec module 212 includes a plurality of codec drivers to decode multimedia files in various formats extracted at the file system module 211. That is, the codec module 212, as illustrated in FIG. 4, includes at least an MPEG-2 codec driver 500, an MPEG-4 codec driver 502, and a DivX codec driver 504, to decode the multimedia files read at the file system module 211 and output the multimedia files to the user interface module 213.

The user interface module 213 reads the multimedia files from the file system module 211 according to a selection signal input via the keypad 250, and outputs the data decoded at the codec module 212 to the display unit 260 or the D/A converter 240. In this embodiment, the user interface module 213 includes a key input unit 600 to receive the selection signals and or key signals input from the keypad 250, a display controller 260 to control the display unit 260, an audio input/output controller 604 to control the A/D converter 230 and the D/A converter 240, and a reproduction mode controller 606 to control a reproduction mode of multimedia files, as illustrated in FIG. 5. The audio post-processing module 214, shown in FIG. 2, is configured to add various types of sound effects to audio signals decoded at the codec module 212. The game engine module 215 is configured to operate games according to game data read from a DVD 300.

The keypad 250 includes a plurality of function keys (such as, a power key, a reproduction mode selection key, and a sound effect operation key) to generate operation signals of a multimedia file player. The DVD player according to the present invention may further include a program memory (not shown) to store predetermined programs needed in initializing the controller 210. In addition, the DVD player can be configured as a portable device.

In the operation of the DVD player, the optical pickup 302 of the loader 200 reads multimedia file data in various formats stored in the DVD 300. Also, multimedia file data of the PC 101 and multimedia file data on the Internet 103 may be downloaded and stored in the memory 220. Here, the controller 210 recognizes the data recording format of the DVD 300 using the recording format recognizer 402 of the file system module 211 and controls the DVD player so that the multimedia file data can be read via the optical pickup 302. In addition, the controller 210 recognizes a recording format of the multimedia file data stored in the memory 220 via the recording format recognizer 402 of the file system module 211. The memory 220 for storing multimedia files may include a memory stick or CD-R, as described above.

As is widely known, the RF amplifier 304 in FIG. 2 converts the read multimedia file data into high-frequency signals (RF signals) via the optical pickup 302, and outputs the high-frequency signals. The digital signal processor 306 converts the high-frequency signals into digital signals and outputs the digital signals to the DVD decoder 308. The DVD decoder 308 corrects errors in the digital signals, descrambles the corrected data, and outputs the resulting data to the controller 210. Here, the DVD decoder 308 is controlled by the loader controller 406 of the file system module 211 within the controller 210, and the multimedia file data recorded on the DVD 300 is encoded or scrambled.

The motor driver 310 that is controlled by the load controller 406 of the file system module alters the rotation speed of the DVD 300 and the data reading location of the optical pickup 302.

The memory controller 404 of the file system module 211 controls the storing of the processed multimedia files input from the loader 200 in the memory 220, and manages the multimedia files of the PC 101 and the multimedia files downloaded from the Internet 103.

The key input unit 600 of the user interface module 213 in FIGS. 1 and 5 receives a multimedia file reproduction signal input via the keypad 250, and outputs the multimedia file reproduction signal to the memory controller 404. The memory controller 404 outputs a multimedia file that corresponds to the multimedia reproduction signal among the multimedia files stored in the memory 220 to the codec module 212. The codec module 212 operates one of the MPEG-2 codec driver 500, the MPEG-4 codec driver 502, and the DivX codec driver 504 that corresponds to a file extension of the multimedia file. For example, the MPEG-2 codec driver 500 is operated when a multimedia (moving picture) file has the file extension “*.mpg”, the MPEG-4 codec driver 502 is operated when a multimedia (moving picture) file has the file extension “*.asf”, and the DivX codec driver 504 is operated when a multimedia (moving picture) file has the file extension “*.avi”. The codec module 212 decodes multimedia files by operating the MPEG-2 codec driver 500, the MPEG-4 codec driver 502, and the DivX codec driver 504, corresponding to each type of multimedia file, restores the multimedia files into video and audio data, and outputs the video and audio data to the user interface module 213. The display controller 602 of the user interface module 213 controls the output of the video data input from the codec module 212 via the display unit 206. In addition, the audio input/output controller 604 of the user interface module 213 outputs the audio data, which is input from the codec module 212, to the D/A converter 240. The D/A converter 240 converts the audio data into analog audio data, and outputs the analog audio data via the speaker 280.

Meanwhile, the audio input/output controller 604 encodes an audio signal via the codec module 212, and stores the audio signal in the memory 220. The audio signal is input via the microphone 270 and converted into digital data by the AID converter 230. Audio signals stored in the memory 220 are output to the speaker 280 through the audio signal reproducing operation described above. When the video and or audio data input from the codec module 212 are output to the display unit 260 and or speaker 280, the reproduction mode controller 606 of the user interface module 213 outputs control signals to manage the reproduction mode. Here, the reproduction mode includes numerous modes such as replay, fast forward, and rewind. That is, when the video and or audio data is output via the display unit 260 and the speaker 280, the reproduction mode controller 606 outputs control signals for replaying, fast forwarding, and rewinding or reversing the video and or audio data, which is reproduced according to key input signals via the key input unit 600, output from the display unit 260 and or the speaker 280.

The audio post-processing module 214 outputs control signals for volume control, base and treble control, and 3D effect, according to the sound effect operation signals input via the key input unit 600, and controls the sound effects of the audio signals output through the speaker 280.

The game engine module 215 decodes the game data stored on the DVD 300 by successive operations of the file system module 211 and the codec module 212, and performs the game using the decoded game data.

The reproduction of multimedia files using the DVD player according to an embodiment of the present invention described above will now be explained in more detail. First, a reproduction signal of a multimedia file of the DVD 300, the PC 101, or downloaded from the Internet 103, is input. Then, the key input unit 600 of the user interface module 213 receives a multimedia file reproduction signal from the keypad 250. The controller 210 selectively reads a multimedia file that corresponds to the reproduction signal input from the DVD 300 or the memory 220 via the key input unit 600, via the loader 200.

The controller 210 decodes a multimedia file stored in the memory 220 via one of the MPEG-2 codec driver 500, the MPEG-4 codec driver 502, and the DivX codec driver 504 of the codec module 212 that corresponds to the multimedia file. Then, the multimedia file is divided into video and audio data. The MPEG-2 codec driver 500, the MPEG-4 codec driver 502, or the DivX codec driver 504 of the codec module 212 that corresponds to the multimedia file outputs the video data to the display unit 260 through the control of the display controller 210 of the user interface module 213. In addition, the corresponding codec driver outputs the audio data, which is decoded and divided, to the D/A converter 240 through the control of the audio input/output controller 604. The D/A converter 240 converts the audio data into an analog signal and outputs it to the speaker 280. Here, the audio post-processing module 214 outputs sound effect control signals (such as, a volume control signal, a base and treble control signal, and a 3D effect signal) to the D/A converter 240 according to the sound effect operation signal input via the keypad 250 by a user. The D/A converter 240 outputs the audio signal, whose sound effects are controlled in various ways according to the sound effect control signal, to the speaker 280.

A method of reproducing multimedia files using the DVD player according to the embodiment of the present invention described above will now be described.

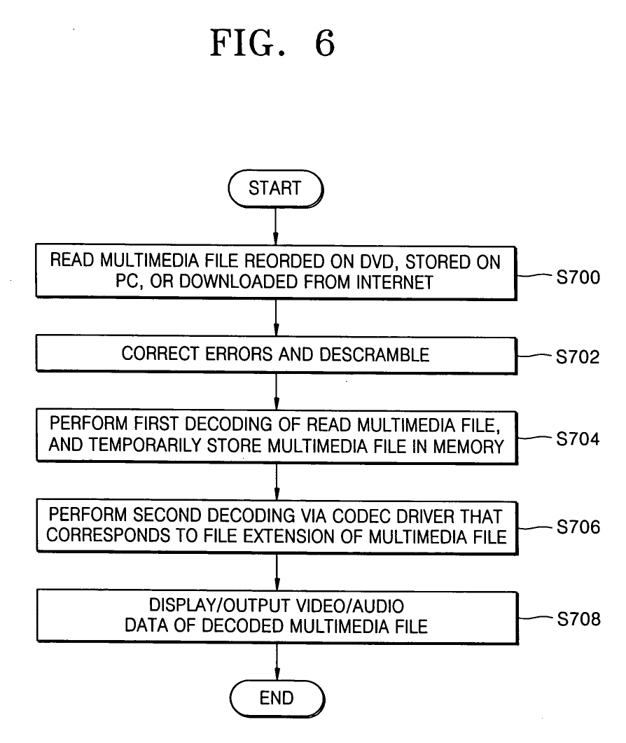

FIG. 6 is a flowchart illustrating a method of reproducing a multimedia file according to an embodiment of the present invention. First, multimedia file data recorded on the DVD 300, a multimedia file of the PC 101, or a multimedia file downloaded from the Internet 103 is read (S700). Next, the read multimedia file data is subject to descrambling and error correction (S702). Then, a first decoding is performed on the resulting multimedia file data and the resulting multimedia file data is stored in the memory 220 (S704). In operation S704, the controller 210 recognizes a recording format of the read multimedia file via the recording format recognizer 402. Also, in the case of the DVD 300, after the multimedia file data is read according to its recognized recording format and converted into a high-frequency signal, the controller 210 decodes the multimedia file data converted into the high-frequency signal to correct errors in the multimedia file data and to descramble the multimedia file data. Here, the overall operation of the loader 200 is controlled by the controller 210. Next, the controller 210 performs a second decoding via one of the MPEG-2 codec driver 500, the MPEG-4 codec driver 502, and the DivX codec driver 504 that corresponds to the file extension of the multimedia file stored in the memory 220 (S706). Here, the second decoding decodes the multimedia file and outputs video and audio data.

The controller 210 outputs video and or audio data of the multimedia file that went through second decoding to the display unit 260 and speaker 280 via the D/A converter 240.

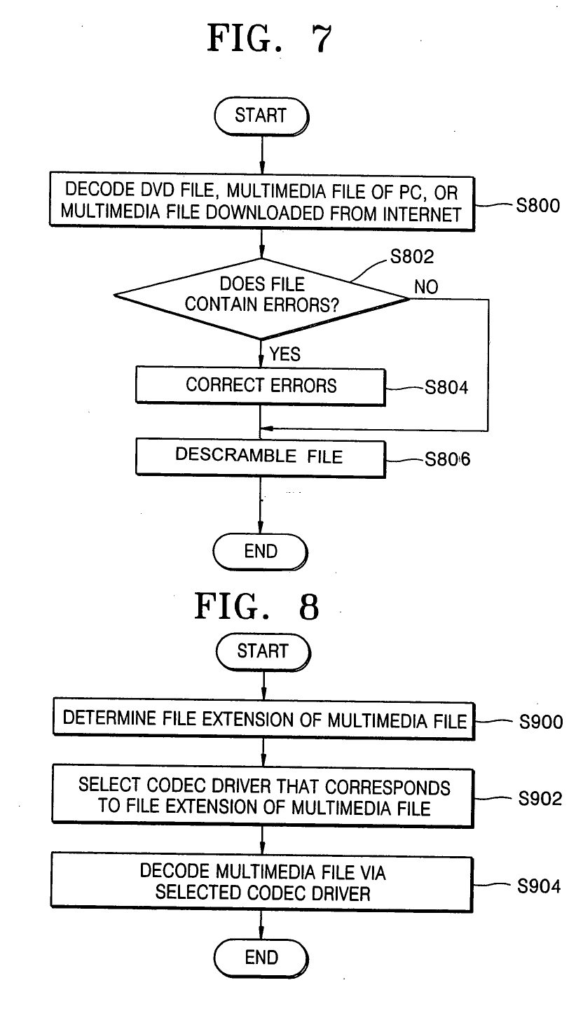

The first decoding process in the method of reproducing the multimedia file according to an embodiment of the present invention will now be described in more detail with reference to FIG. 7, which is a flowchart illustrating an exemplary first decoding process. First, multimedia file data recorded on the DVD 300, a multimedia file of the PC 101, or a multimedia file downloaded from the Internet 103 is decoded (S800). The controller 210 checks whether any errors are included within the read multimedia file data (s802). If errors are detected in the read multimedia file in S800, the DVD 300 corrects the errors (S804) and performs descrambling to decode the encoded multimedia file data (S806).

An exemplary second decoding process in the method of reproducing the multimedia file according to an embodiment of the present invention will now be described in more detail with reference to FIG. 8, which is a flowchart illustrating the second decoding process. First, the controller 210 determines the file extension of the multimedia file stored in the memory 220 (S900), and selects one of the MPEG-2 codec driver 500, the MPEG-4 codec driver 502, and the DivX codec driver 504 that corresponds to the determined file extension (S902). That is, the controller 210 selects the MPEG-2 codec driver 500 when the multimedia file has the file extension “*.mpg”, selects the MPEG-4 codec driver 502 when the multimedia file has the file extension “*.asf”, and selects the DivX codec driver 504 when the multimedia file has the file extension “*.avi”. Afterwards, the controller 210 decodes the multimedia file via the selected codec driver, and outputs video and audio data (S904).

According to a DVD player and a method of reproducing multimedia files using the same, embodiments of the present invention can improve the practical applicability and the usefulness of a common DVD player by enabling reproduction of multimedia information stored in various multimedia formats (e.g., MPEG-4, DivX) via codecs. Codecs that correspond to each of the multimedia format are downloaded via a memory stick or other external port so that not only moving picture multimedia information stored in MPEG-2 format, which is the basic DVD format, but also multimedia information recorded in various other multimedia formats such as MEPG-4 and DivX, can be reproduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A digital versatile disc (DVD) player, comprising:
a loader that reads multimedia file data stored on a DVD;
a memory that stores the multimedia file data read by the loader, and multimedia file data of a personal computer (PC) or multimedia file data downloaded from the Internet; and
a controller that controls the loader and the memory,
wherein the controller includes:
a file system module that controls the reading of the multimedia file data by the loader and controls the read multimedia file data by extracting a portion or the entire multimedia file from the multimedia file data;
a codec module that decodes the multimedia file using a codec driver that corresponds to the file extension of the multimedia file stored in the memory; and
a user interface module that outputs video and or audio data of the decoded multimedia file to a video and or audio output device,
wherein the codec module includes a plurality of codec drivers to decode multimedia files in a plurality of formats and the memory is composed of a memory stick or a CD-R.

2. The DVD player of claim 1, wherein the file system module comprises:
a recording format recognizer that recognizes a recording format of the multimedia file data stored in the memory;
a memory manager that manages the memory;
a loader controller that controls a loading location of the multimedia file data; and
a decoding controller that controls a first decoding of the multimedia file data read by the loader.

3. The DVD player of claim 1, wherein the codec module comprises at least an MPEG (moving picture experts group)-2 codec driver, an MPEG-4 codec driver, and a DivX (digital video express) codec driver according to the file extension of the multimedia file stored in the memory, and other codec drivers that decode a plurality of multimedia files are added in the codec module through software upgrade.

4. The DVD player of claim 1, wherein the user interface module comprises:
a key input unit that receives signals input by a user;
a display controller that controls output of video data of the multimedia file decoded in the codec module;
an audio input and or output controller that controls output of audio data of the multimedia file decoded in the codec module; and
a reproduction mode controller that outputs a control signal that controls a reproduction mode of the multimedia file to the file system module.

5. The DVD player of claim 1, wherein the loader comprises:
an optical pickup that reads multimedia file data stored in the DVD;
a radio frequency amplifier that converts the multimedia file data read by the optical pickup into high-frequency signals; and
a digital signal processor that converts the multimedia file data that is converted into the high-frequency signals into digital signals.

6. The DVD player of claim 1, wherein the file system module, the codec module, and the user interface module are configured in a software module, respectively.

7. A method of reproducing multimedia files using a DVD player, the method comprising:
reading a multimedia file stored in a DVD and performing a first decoding;
storing the multimedia file that went through the first decoding, and storing a multimedia file of a PC or a multimedia file downloaded from the Internet;
performing a second decoding by a codec driver that corresponds to a file extension of the stored multimedia file; and
outputting video and or audio data of the multimedia file that went through the second decoding to a video and or audio output device.

8. The method of claim 7, wherein the second decoding comprises:
determining the file extension of the multimedia file;
selecting a codec driver that corresponds to the determined file extension; and
performing decoding using the selected codec driver, and outputting video and audio data.

9. A computer-readable medium having computer-executable instructions arranged for performing a method of managing the presentation of medical data comprising the steps of:
reading a multimedia file stored in a DVD and performing a first decoding;
storing the multimedia file that went through the first decoding, and storing a multimedia file of a PC or a multimedia file downloaded from the Internet;
performing a second decoding by a codec driver that corresponds to a file extension of the stored multimedia file; and
outputting video and or audio data of the multimedia file that went through the second decoding to a video and or audio output device.

10. A computer-readable medium having computer-executable instructions arranged for performing a method of claim 9, wherein the second decoding comprises:
determining the file extension of the multimedia file;
selecting a codec driver that corresponds to the determined file extension; and
performing decoding using the selected codec driver, and outputting video and audio data.
